(19) United States
(12) Patent Application Publication
(10) Pub. No.: US 2012/0057983 A1
(43) Pub. Date: Mar. 8, 2012

(54) METHOD FOR FORMING SURFACE LAYER, METHOD FOR FORMING EROSION RESISTANT COMPONENT AND STEAM TURBINE BLADE

(75) Inventors: Akihiro Goto, Tokyo (JP); Hiroyuki Teramoto, Tokyo (JP); Nobuyuki Sumi, Tokyo (JP); Yoshikazu Nakano, Tokyo (JP)

(73) Assignee: MITSUBISHI ELECTRIC CORPORATION, Tokyo (JP)

(21) Appl. No.: 13/321,420

(22) PCT Filed: May 20, 2009
(86) PCT No.: PCT/JP2009/002230

§ 371 Date: Nov. 18, 2011

(51) Int. Cl. F01D 5/14; B05D 7/00; B05D 5/00

(52) U.S. Cl. 416/224; 427/580

(57) ABSTRACT

A method for forming a surface layer, the method including: arranging a member in a machining fluid; and forming a surface layer including silicon by supplying silicon component from the silicon electrode to the member side by applying a predetermined voltage and generating electric discharge, wherein a value of an electric discharge detection level is set to be equal to or larger than a value obtained by adding a voltage depression at the silicon electrode to an arc potential during electric discharge, and wherein the surface layer is formed on a surface of the member by repetitively performing, after the voltage is applied, detecting the electric discharge generated between the silicon electrode and the member by detecting a drop of the voltage to be lower than the electric discharge detection level, stopping applying the voltage for a predetermined time, and applying the voltage again after a predetermined break time.

### TECHNICAL FIELD

The present invention relates to erosion resistant components and a forming method thereto.

### BACKGROUND ART

Erosion, such as a member being eroded by collision with wet steam including water droplet at a high speed, is a critical issue in a steam turbine blade, piping of a pump and fluid injection components, and various efforts against the erosion have been made.

JP-A-2006-124830 discloses that an erosion resistance performance is obtained by forming a protective structure made of a material such as α-β titanium alloy, near β titanium alloy or β titanium alloy on turbine components, with respect to an erosion resistant structure using a film or clad made of a conventional cobalt base alloy such as Stellite (registered trademark) and Haynes 25. (registered trademark) (Patent Literature 1)

Also, Japanese Patent No. 3001592 discloses that, as a measure for erosion resistant to a steam turbine, Cr₃C₂ with stainless powder as binder is thermally sprayed into the turbine components (Patent Literature 2).

Also, JP-A-2006-70297 discloses a method for improving erosion resistance, in which a surface of a carbide film is melted by a heat source having a high energy density such as laser or EBW to perform a sealing process after the carbide film is formed on a steam turbine member by high-pressure high-velocity flame spraying (Patent Literature 3).

### Citation List

### Patent Literature

Patent Literature 1: JP-A-2006-124830

Patent Literature 2: Japanese Patent No. 3001592

Patent Literature 3: JP-A-2006-70297

### SUMMARY OF INVENTION

### Technical Problem

As described above, various methods have been attempted as the measure for erosion resistant. However, in Patent Literature 1, in formation of the structure, there is required a difficult method in which the structure is pushed toward a member with high temperature and high pressure to perform diffusion bonding. In Patent Literature 2, because a large number of voids exist in the formed film, the erosion resistance is insufficient. Further, the performance deterioration as the steam turbine, which is attributable to existence of the voids, is not taken into consideration. In Patent Literature 3, there arises a problem that the surface is melted by a method using high energy density such as laser whereby heat influence remains, and strain remains in the member.

That is, in the method of attaching another material to the member such as welding or brazing, an excessive heat is input to the member. Therefore, deformation of the member and deterioration of strength cannot be avoided. Those methods are manually performed, and require skill. The erosion resistant performance cannot be obtained sufficiently. There arise these problems.

Also, as the materials suitable for the erosion resistance, various materials have been tried as disclosed in the above-mentioned patent literatures. However, under the existing circumstance, a material that is sufficiently satisfactory has not been found.

Two reasons are roughly conceivable for this.

A first reason is that the material suitable for the erosion resistance has not yet been clarified in theory. Erosion is generated by collision with water droplet or foreign material as the primary cause. However, harder material is not always excellent in the erosion resistance. Various materials are subjected to a process of trial and error, and under the existing circumstances, a material such as Stellite (registered trademark) has been widely used.

A second reason is that even when there is a material excellent in the erosion resistance, at many times, it is difficult to attach the material onto a member to be treated.

At present, various coating technologies have been developed so that even a hard material can be attached onto the surface of the member to be treated. However, treatment itself is frequently limited. For example, in the case of a large member such as the steam turbine blade, it is extremely industrially difficult to insert the member itself into a vacuum device, and treat the member one by one.

An object of the present invention is to form an excellent erosion resistant film which solves the above problems. In particular, for the purpose of avoiding excessive heat input and reducing a unit of energy to be used when attaching a material to a member, a heat effect on the member is reduced with the use of a fine pulse discharge, resulting in that deformation and deterioration in strength can be reduced as much as possible.

Also, there is provided a method that can implement treatment of the member mechanically and automatically without depending on skill.

### Technical Solution

### ADVANTAGEOUS EFFECTS OF INVENTION

A method for forming a surface layer of the present invention includes: arranging a member in a machining fluid; and forming a surface layer including silicon by spacing an silicon electrode from the member by a predetermined distance, and by supplying silicon component from the silicon electrode to the member side by applying a predetermined voltage and generating electric discharge, and is characterized in that a member having a specific resistance of 0.005 Ωcm or lower is selected as the silicon electrode, a value of an electric discharge detection level is set to be equal to or larger than a value obtained by adding a voltage depression at the silicon electrode to an arc potential during electric discharge, and the surface layer including silicon is formed on a surface of the member by repetitively performing, detecting the electric discharge generated between the silicon electrode and the member by detecting a drop of the voltage to be lower than the electric discharge detection level, stopping applying the voltage for a predetermined time after the electric discharge is generated, and applying the voltage again after a predetermined break time.

According to the present invention, by an electric discharge using an Si electrode, a high-quality film can be stably formed on the member, and a surface layer can be formed which exerts a high erosion resistance.

Also, an improvement in the erosion resistance of the steam turbine blade, piping components, or the fluid injection components can be performed without relying on manpower and without dispersion.

### BRIEF DESCRIPTION OF THE DRAWINGS

FIG. 1 is an illustrative diagram of an electric discharge surface treatment system.

FIG. 2 is a diagram illustrating voltage and current waveforms in an electric discharge surface treatment.

FIG. 3 is a diagram illustrating an electric discharge phenomenon.

FIG. 4 is a diagram illustrating a relationship of a resistance value R, a resistivity ρ, an area S, and a length L.

FIG. 5 is a diagram illustrating a current waveform when electric discharge cannot be detected.

FIG. 6 is a cross-sectional photograph of a surface layer including Si according to the embodiment.

FIG. 7 is a surface photograph of the surface layer machined under a machining condition in which a pulse width is about 130 μs.

FIG. 8 is a diagram illustrating an analysis result of the surface layer including Si.

FIG. 9 is a schematic diagram of an evaluation test of erosion resistance.

FIG. 10 is a diagram illustrating an evaluation test result of stainless base material.

FIG. 11 is a diagram illustrating an evaluation test result of Stellite.

FIG. 12 is a diagram illustrating an evaluation test result of a TiC film.

FIG. 13 is a diagram illustrating one evaluation test result of a surface layer of Si.

FIG. 14 is a diagram illustrating another evaluation test result of the surface layer of Si.

FIG. 15 is a diagram illustrating an appearance in which an Si surface layer is formed on a steam turbine rotor blade.

FIG. 16 is a diagram illustrating an appearance in which the Si surface layer is formed on the steam turbine rotor blade.

FIG. 17 is a diagram illustrating an appearance in which the Si surface layer is formed on the steam turbine rotor blade.

### EMBODIMENTS OF INVENTION

Hereinafter, embodiments of the present invention will be described with reference to the drawings.

### First Embodiment

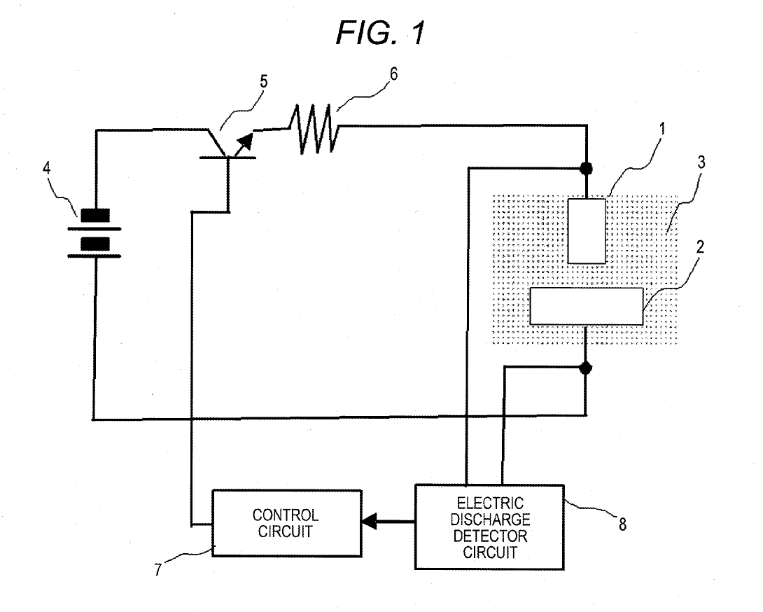

FIG. 1 illustrates an outline of an electric discharge surface treatment method in which pulsed electric discharge is generated between an Si electrode and a member, and a texture having an erosion resistant function is formed on a surface of the member.

In the figure, reference numeral 1 is a solid metal silicon (Si) electrode, 2 is a member to be treated such as a steam turbine blade, 3 is an oil that is a machining fluid, 4 is a DC power supply, 5 is a switching element for applying (or stopping) a voltage of the DC power supply 4 between the Si electrode 1 and the member 2, 6 is a current-limiting resistor for controlling a current value, 7 is a control circuit for controlling on/off operation of the switching element 5, and 8 is an electric discharge detector circuit for detecting the voltage between the Si electrode 1 and the member 2 to detect the generation of electric discharge.

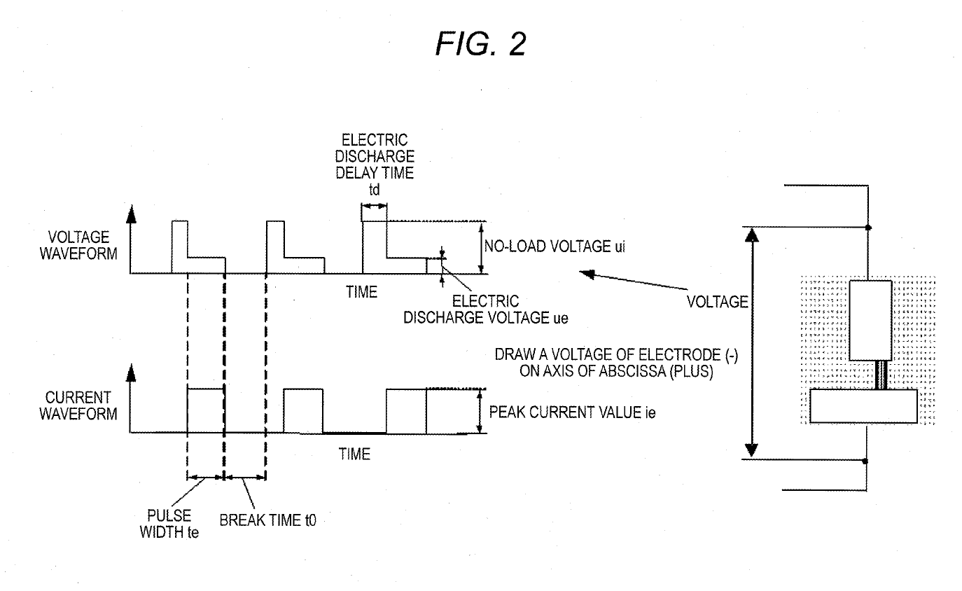

Subsequently, the operation will be described with reference to FIG. 2 illustrating voltage and current waveforms.

When the switching element 5 is turned on by the control circuit 7, a voltage is applied between the Si electrode 1 and the member 2. With an electrode feed mechanism which is not shown, an interpolar distance between the Si electrode 1 and the member 2 is controlled to an appropriate distance (a distance allowing electric discharge to be generated), and after a short time, electric discharge is generated between the Si electrode 1 and the member 2. A current value ie of a current pulse, a pulse width te (electric discharge duration), and an electric discharge break time t0 (a time during which no voltage is applied) are set in advance, and determined according to the control circuit 7 and the current-limiting resistor 6.

When the electric discharge is generated, the electric discharge detector circuit 8 detects the generation of electric discharge according to a decrease in the voltage between the Si electrode 1 and the member 2, and timing, and the control circuit 7 turns off the switching element 5 a predetermined time (pulse width te) after the electric discharge is detected.

The control circuit 7 again turns on the switching element 5 a predetermined time (break time t0) after the switching element 5 turns off.

The above operation is repetitively performed so that the electric discharge of a continuously set current wave can be generated.

In FIG. 1, the switching element is illustrated as a transistor. However, another element may be used if the element can control the application of a voltage. Also, the current value is controlled by the resistor. However, it is needless to say another element may be used if the element can control the current value.

Also, in the illustration of FIG. 1, the waveform of the current pulse is a rectangular wave. However, another waveform may be used. A large amount of Si material can be supplied by increasing the consumption of the electrode, or the material can be effectively used by reducing the consumption of the electrode, depending on the shape of the current pulse. However, this will not be discussed in detail in the present specification.

As described above, a layer including a large amount of Si therein can be formed on a surface of the member 2 by continuously generating electric discharge between the Si electrode 1 and the member 2. However, in order to stably form the high-quality Si contained layer, not all kinds of Si can be used. Also, there is a necessary condition in the circuit of FIG. 1. The condition will be described in detail later.

First, prior to the description of conditions of the Si electrode and the circuit, in order to clarify differences of the electric discharge surface treatment between the conventional art and this embodiment, a film formation technology using the electric discharge machining will be described. JP-B-5-13765 discloses a technique in which, with the use of silicon as an electrode of the electric discharge machining, an amorphous alloy layer or a surface layer of high corrosion resistant and high heat resistant characteristics with a fine crystal structure is formed on a surface of a workpiece.

The electric discharge machining by the Si electrode disclosed in that publication is performed by a technique in which an energy having a peak value Ip of 1 A is supplied through a circuit system that turns on/off a voltage periodically with a voltage application time fixed to 3 μs and a break time fixed to 2 μs. For that reason, in a period of 3 μs during which the voltage is applied, where of the voltage pulse to generate each electric discharge is different from each other, and the current pulse width which is a real electric discharge duration where a current flows is successively changed, and the stable film formation is difficult.

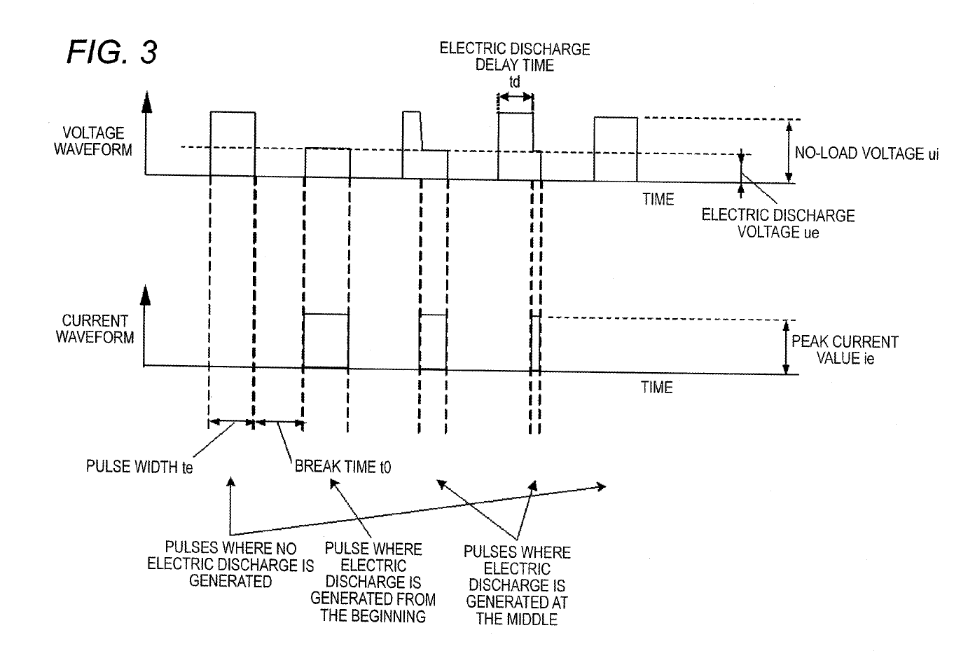

For example, as exemplified in FIG. 3, in a power supply of a circuit system in which the voltage periodically turns on and off, a voltage waveform and a current waveform are changed, and a phenomenon that energy for each pulse is different occurs. Also, the amount of Si, which is an electrode material, to be supplied to the member and energy for melting the surface of the member to form the surface layer are varied. Therefore, stable treatment is difficult.

In the drawing, a voltage of the electric discharge is constant, and a current thereof is also constant. However, actually, the voltage fluctuates, and also the current fluctuates. Also, when the electrode is made of a high resistant material such as Si, because a voltage depression attributable to Si is also included in the voltage, the voltage is high, and the fluctuation also becomes large.

Subsequently, a reason that the voltage must be periodically turned on and off in the publication as described above will be described.

In the publication, a condition of a very small current pulse is made with the use of silicon which is a high resistant material about 0.01 Ωcm in specific resistivity.

For that reason, in the conventional control system that detects an arc potential of electric discharge to detect the generation of electric discharge, in the case where electric discharge is generated when the electrode is made of the high resistant material, a value, in which a voltage of the voltage depression when a current flows in the Si electrode is added to the arc potential, is detected. When the voltage of the voltage depression is high, the circuit cannot recognize that electric discharge is generated despite the generation of electric discharge.

Also, the silicon film produced by the conventional electric discharge machining suffers from a problem that the treatment is largely varied, and cannot be stably performed.

This problem is also attributable to a fact that Si is high in resistance.

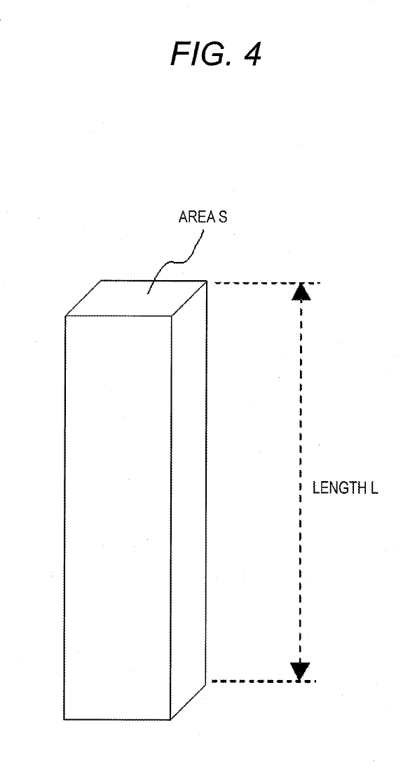

For example, when it is assumed that a resistance value is R, a resistivity is ρ, an area is S, and a length is L as illustrated in FIG. 4, a resistance value R of the electrode is represented by R=ρ·L/S.

However, if ρ is large, a value of R is largely varied according to a method for supplying electricity to the electrode, that is, an electrode holding method.

In the conventional art, silicon of ρ=0.01 Ωcm is used as the electrode. However, in the case of the material having such a high resistance, the treatment cannot be performed without any condition. For example, when the Si electrode is long, electricity is fed to the electrode while holding one end of the electrode, the resistance of the electrode is higher if the electrode is longer, and the resistance becomes lower as the length is shorter. When the electrode is long and the resistance is high, electric discharge cannot be detected as described above, and a probability that an abnormal pulse is generated is also high. Even if no abnormality occurs, because the resistance is high, a current value of electric discharge becomes low.

Through the research of the present inventors, when silicon having a resistance value of about ρ=0.01 Ωcm is used as the electrode, if the electric discharge is generated when an electrode length becomes about several tens mm or higher, the voltage depression at the electrode, which is attributable to a current, becomes large, abnormal electric discharge is generated, and the formation of the surface layer becomes difficult.

Also, it has been found that a condition under which such abnormal electric discharge is generated is determined according to an electricity feed position and an electric discharge position, that is, a length of the electrode, and is irrelevant to an area (thickness) of the electrode.

It can be assumed that this is because when a current flows in the electrode, the current does not uniformly flows over the entire cross section of the electrode, but flows in a certain thin channel. Accordingly, even when silicon having a resistivity of 0.01 Ωcm or more is used as the electrode, if a position where the electric discharge is generated and an electricity feed point are brought closer to each other, suitable electric discharge can be generated. If plate-like silicon of, for example, about 1 mm is joined to a metal for feeding electricity, even if the resistance value is about 0.05 Ωm, stable electric discharge is enabled. However, when even the electrode of 0.01 Ωcm has a length of about several tens mm or more, for example, about 100 mm, abnormal electric discharge may be generated, and stable treatment is difficult.

The following facts have been proved from the experiments of the present inventors as discussed above.
In order to form the surface layer including Si on the surface of the member through the use of pulse discharge in oil with silicon as the electrode, with a thickness of about 10 μm so as to withstand industrial use, at a high speed, Si low in resistance is used, and a circuit of a system that controls (substantially uniforms the pulse widths) pulse widths (electric discharge current pulses) of electric discharge as illustrated in FIGS. 1 and 2 must be used.
In order to form the surface layer of about 10 μm or more on the member surface with silicon as the electrode, a lower resistance value (specific resistance) is preferable. When it is assumed that the electrode having a length of about 100 mm or higher is used from the viewpoint of actual industrial use, it is desirable that ρ is 0.005 Ωcm or lower. In order to decrease the resistance value of Si, the concentration of so-called impurity can be increased such that Si is doped with other elements.
When the electricity feed point and the electric discharge position are brought closer to each other, even if ρ is 0.005 Ωcm or more, stable treatment can be performed. An index in this situation may be provided as follows, including a case in which ρ is 0.005 Ωcm or lower.

That is, it is recognized that electric discharge is generated by a decrease in a voltage applied between poles. A power supply allows the application of the voltage to be stopped (that is, electric discharge is stopped) a predetermined time (pulse width te) after it is recognized that the electric discharge is generated. With this power supply, in forming the surface layer including Si on the surface of the member with Si as the electrode, the treatment can be performed in a state where an interpole voltage including voltage depression at the Si electrode, which is a resistor when electric discharge is generated, becomes lower than an electric discharge detection level.

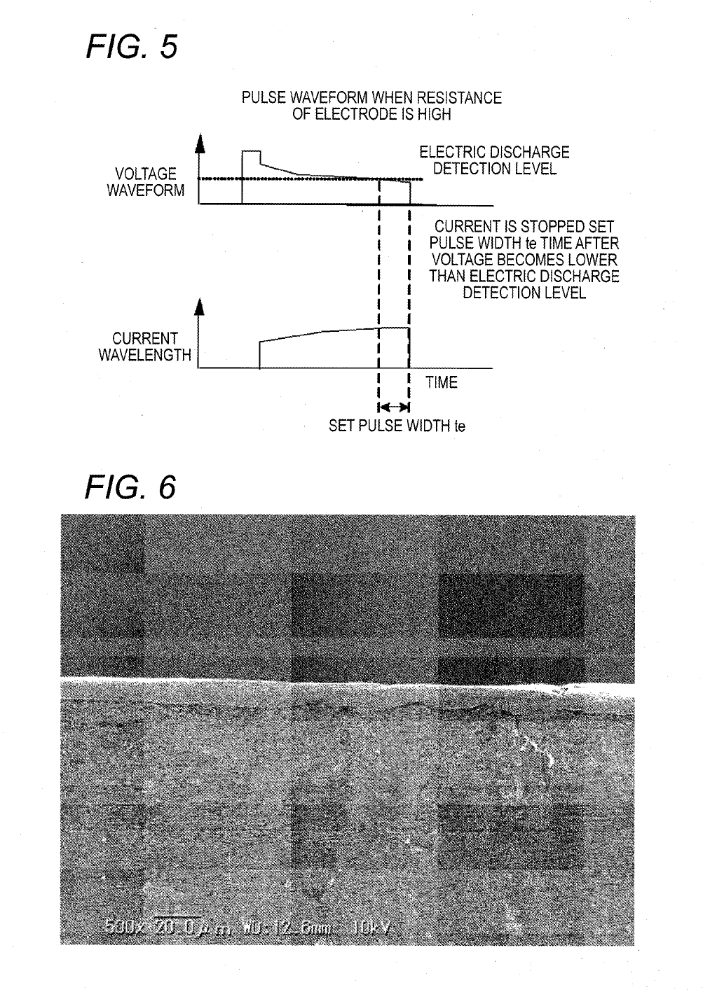

In general, a potential of the arc is about 25V to 30V. A voltage of the electric discharge detection level may be set to be lower than the supply voltage, and higher than the potential of the arc. However, if the electric discharge detection level is set to be low, unless the resistance value of Si is decreased, the generation of electric discharge cannot be recognized even if the electric discharge is generated. As a result, a risk, in which an abnormally long pulse is generated as illustrated in FIG. 5, increases.

If the electric discharge detection level is set to be high, even if the resistance of Si is slightly high, the interpole voltage is liable to fall below the electric discharge detection level when the electric discharge is generated. That is, when the resistance value of Si is low, the electrode may be long. When the resistance value of Si is high, the length of Si is shortened so that the interpole voltage when electric discharge is generated becomes lower than the electric discharge detection level. Although the electric discharge detection level may be set to be lower than the supply voltage and higher than the potential of the art, according to the above description, it is preferable that the electric discharge detection level is set to a level slightly lower than the supply voltage.

Through the experiment of the present inventors, there has been found that to set the electric discharge detection level to a value lower than the supply voltage by about 10 to 30 V has the highest versatility in the practical use. More strictly, by setting the electric discharge detection level to a value lower than the supply voltage by about 10 to 20 V, there is a wide range in the kinds of Si that can be used.

When the above conditions are satisfied, flexible electric discharge pulse can be stably generated with the use of Si, which is a high resistant material, as the electrode, and the surface including Si can be formed on the member.

FIG. 6 is a cross-sectional photograph of a surface layer including Si formed according to the present invention.

The surface layer is formed with the pulse width te=16 μs, and the peak current value ie=10 A.

The peak current value ie has been tested in a range of 1 to 40 A. Whether the film can be formed or not does not depend particularly on a magnitude of the peak current value ie. When the peak current value ie is larger, advantageously, there is a tendency that the treatment time is short. On the other hand, disadvantageously, the consumption of the electrode increases, and liable to be wasteful. However, although the increase in electrode consumption is disadvantageous, in an applied example in which it is desired that the electrode quickly conforms to a shape of the workpiece, it is desirable to consume the electrode as quickly as possible. In this situation, an increase in the consumption of the electrode is advantageous.

According to the present invention, electric discharge is detected when the electric discharge detection level becomes a value lower than the supply voltage by about 10 to 30V, and the pulse width after the electric discharge has been detected can be stabilized to an arbitrary value. Therefore, both of the longer pulse and the shorter pulse can be used. If the shorter pulse is used, a thickness of the formed surface layer is thinned, and if the longer pulse is used, the thickness is thickened.

However, if the pulse is too long, the surface is liable to be cracked. Therefore, the pulse width te is set to be desirably about 100 μs, and more desirably about 60 μs or lower. Conversely, if the pulse width te is shorter, the treating time becomes short. Therefore, a pulse of 4 μs or higher is desirable in practical use. The film can be formed even if the pulse width te is 2 to 3 μs. However, it takes extremely long time, and the film formation is difficult in practical use except for small components.

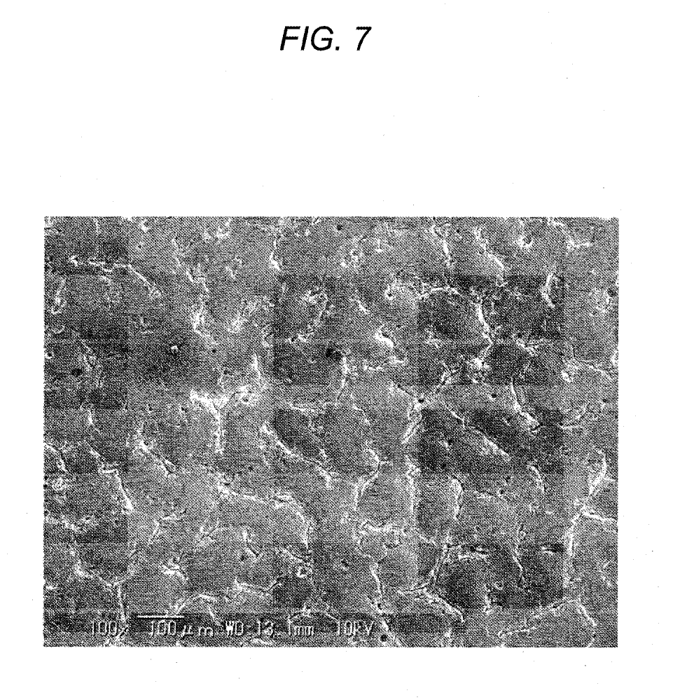

FIG. 7 is a surface photograph of the surface layer formed under a condition in which a pulse width is about 130 μs. It is found that there are many cracks.

The relatively thick surface layer including Si can be formed as described above, and as a result of investigating the properties, the following properties have been found.

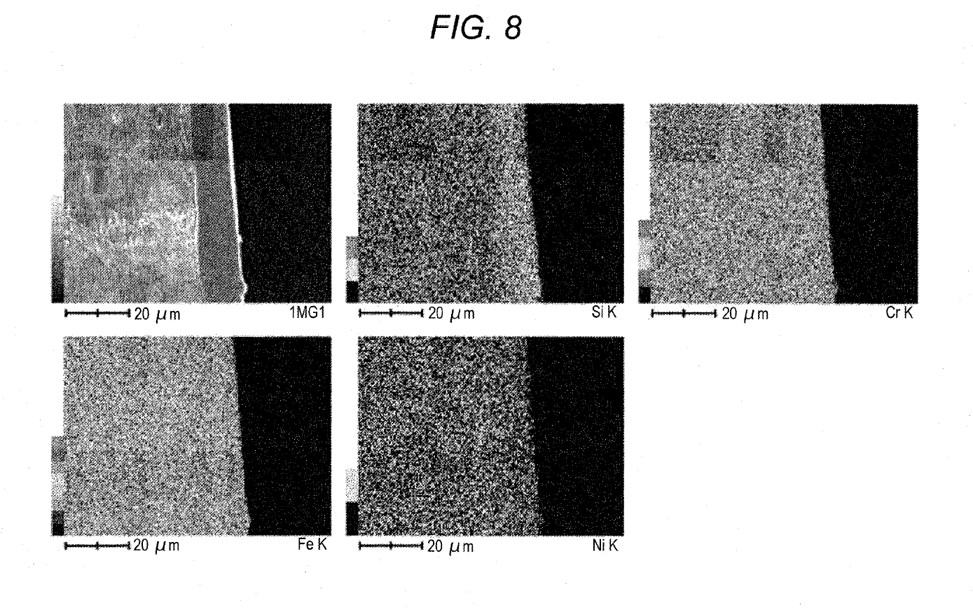

FIG. 8 illustrates an analysis result of the surface layer including Si.

It is found that a layer of Si is configured such that Si is not put on the surface of the member, but an Si mixed layer in which the material of the member is mixed with Si is formed on the surface of the member.

From this result, it is found that the surface layer has a certain level of thickness, and Si is integrated with a base material to provide a high-adhesion surface layer. As a result of investigating the surface layer, it has been found that the surface layer has an extremely high erosion resistance. The erosion is a phenomenon that a member is eroded by water colliding with the member, which causes a failure in piping components through which water or steam passes or the rotor blade of the steam turbine. As technologies for erosion resistance, there are various prior art as described above. However, the respective prior art are has problems.

In the erosion resistance performance according to this embodiment, the test results will be described below.

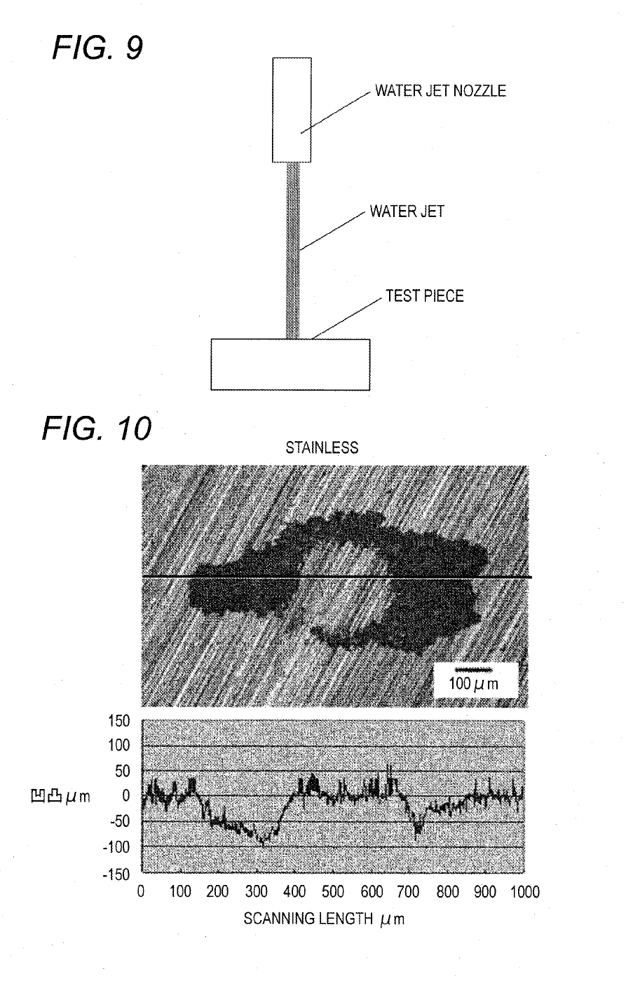

FIG. 9 illustrates an outline of tests in which a water jet is applied to test pieces to compare appearances of erosion with each other as the evaluation of the erosion resistance.

The water jet is applied under a pressure of 200 MPa. The test pieces as used include four kinds of 1) stainless base material, 2) Stellite (material intended for erosion resistance, 3) a TiC film by electric discharge, and 4) a surface layer including a large amount of Si according to the present invention, which is formed on stainless steel.

The film of 3) is a TiC film formed through a method disclosed in WO 01/005545, which has a high hardness.

The water jet is applied to the respective test pieces for 10 seconds, and the erosion of the test pieces is measured by a laser microscope.

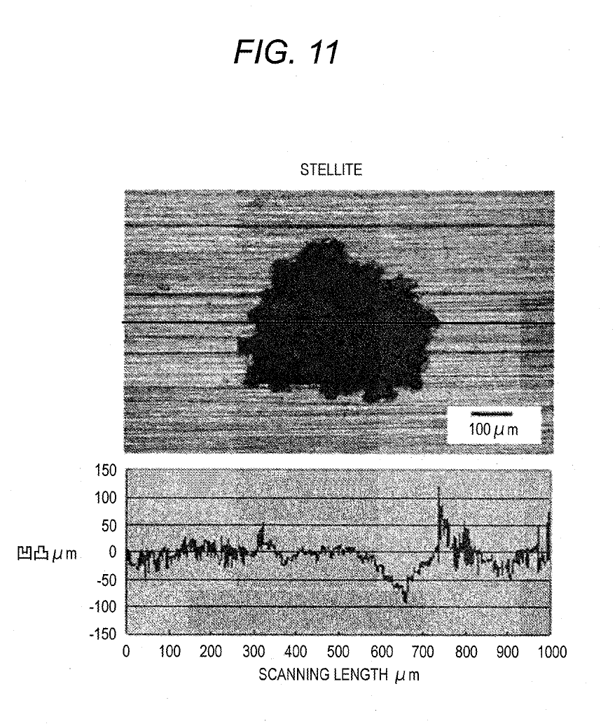

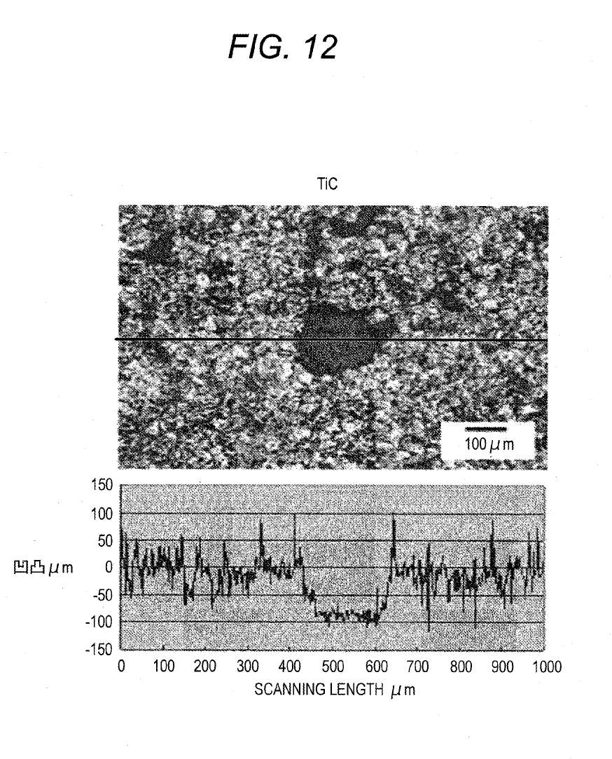

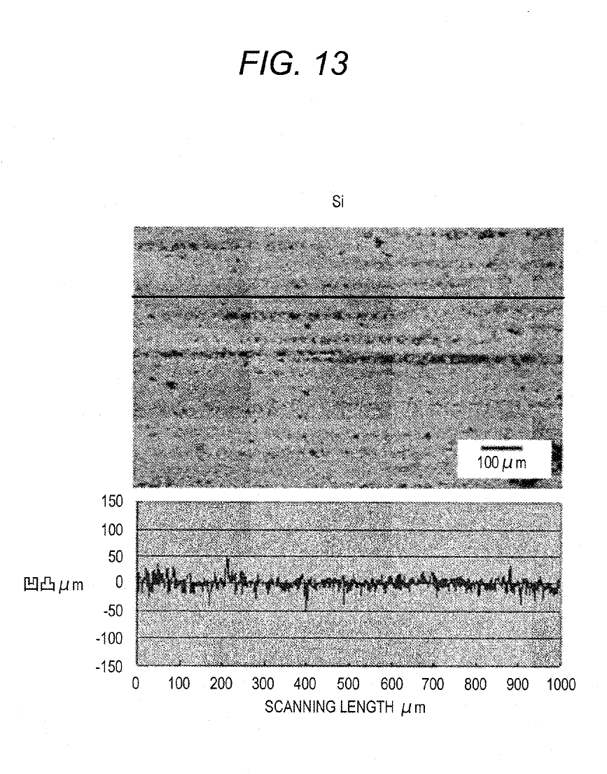

FIG. 10 illustrates a result of 1), FIG. 11 illustrates a result of 2, FIG. 12 illustrates a result of 3), and FIG. 13 illustrates a result of 4), that is, in the case of the surface layer according to this embodiment.

As illustrated in FIG. 10, the stainless base material is eroded to a depth of about 100 μm when the water jet is applied to the stainless base material for 10 seconds.

On the contrary, as illustrated in FIG. 11, in the Stellite material, although the appearance of erosion is different, the depth is about 60 to 70 μm, and the erosion resistance of the Stellite material is confirmed to some extent.

FIG. 12 illustrates the result of the TiC film that is very high in hardness. The TiC film is eroded to the depth of about 100 μm, and from this result, it is found that the erosion is caused by not only the hardness of the surface.

On the other hand, FIG. 13 illustrates the result in the case of the surface layer of Si according to this embodiment. It is found that the surface layer is hardly eroded.

The hardness of the surface layer is about 800 HV (because the thickness of the surface layer is thin, the hardness is measured by a micro Vickers hardness meter with a load of 10 g. A range of the hardness is about from 600 to 900 HV.). This hardness is higher than that of the stainless base material (about 350 HV) illustrated in 1), or the Stellite material (about 420 HV) illustrated in 2), but lower than that of the TiC film (about 1500 HV) illustrated in 3).

That is, it is found that the erosion resistance is a multiple effect related to not only the hardness but also other properties.

In FIG. 12, it appears that the film is hollowed regardless of the hard film. Therefore, it is guessed that even if only the surface is hard, when the surface is not tough and the film is thin, the film is destroyed by impact of the water jet.

On the contrary, according to another test, the film of 4) according to this embodiment is tough and has a surface that withstands deformation. It is guessed that this causes a high erosion resistance. Experimentally, the TiC film and the Si surface layer are formed on a thin plate surface. When a bending test is performed, the TiC film is immediately cracked, but the Si surface layer is hardly cracked.

The surface layer of 4) is tested with a thickness of about 5 μm. However, if the film is thin, it is confirmed that the strength is not sufficient, and the film is liable to be eroded.

In JP-B-5-13765 that is prior art, the Si film is researched, and although a high corrosion resistance is shown, the erosion resistance cannot be found. It can be guessed that one of the major reasons the erosion cannot be found is because the surface layer cannot be thickened.

In the case of the erosion resistance, although depending on a collision speed of a material such as water which causes erosion, it is desirable that the surface layer is 5 μm or more. When the speed of the colliding material is low, the effect may be sufficiently exerted if the surface layer is 2 to 3 μm or more.

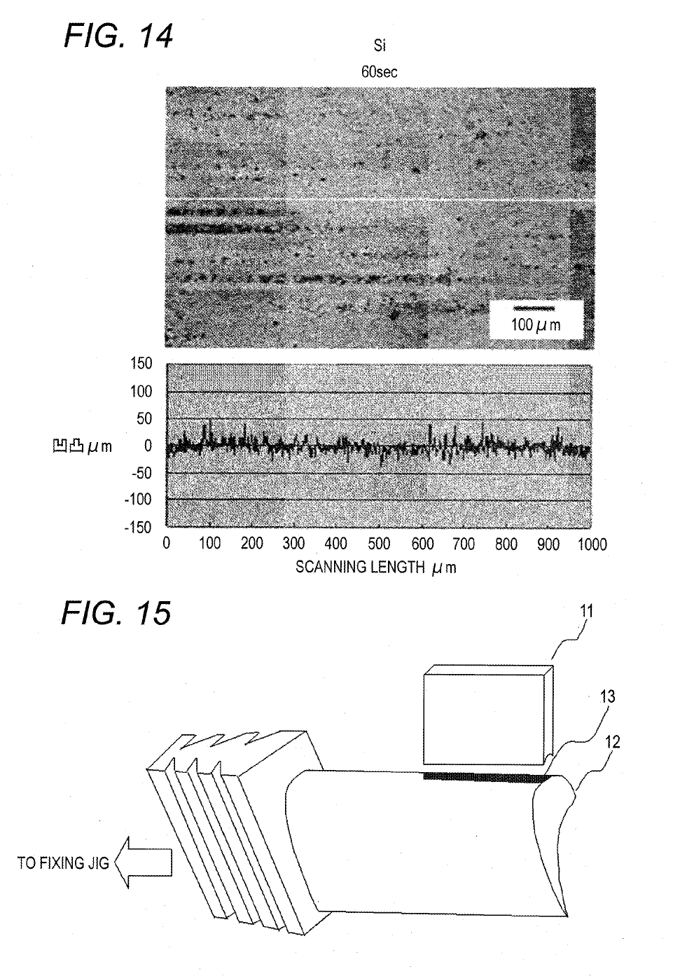

In the test on the surface layer of Si illustrated in 4), erosion can be hardly recognized. Therefore, the test on the surface layer of Si is extended, and the water jet is continuously applied to the surface layer for 60 seconds. This result is illustrated in FIG. 14.

An area to which the water jet is applied is slightly polished and can be discriminated. However, it is found that the area is hardly abraded.

As a result, the high erosion resistance of the surface layer according to this embodiment can be confirmed.

It is understood that the high erosion resistant surface layer is obtained according to this embodiment. The real application technology will be described.

In the following application technology, a technology in which the base technology described above is applied to a real intended purpose will be described. Therefore, in the following description, it is assumed that the technology described above is used, and the same description is not repeated.

FIG. 15 illustrates an appearance in which the Si surface layer of the present invention is formed on a steam turbine rotor blade where the erosion is frequently problematic.

In the figure, reference numeral 11 is an Si electrode, 12 is a steam turbine rotor blade that is a member to be treated, and 13 is a surface layer including Si which is formed on the surface of the steam turbine rotor blade 12. The steam turbine rotor blade 12 is positioned by a jig not shown, and fixed. In a real machining, if a tree part of a base is fixed, the steam turbine rotor blade can be stably fixed.

In the surface layer formation by electric discharge, there is a need to immerse an electric discharge part in oil. Therefore, it is convenient to install the jig not shown in a work tank for saving the oil in practical use.

In the case of the steam turbine, erosion occurs in a front edge of the rotor blade as described in the above-mentioned Patent Literatures.

In the figure, the Si electrode conforming to a shape of a side requiring the erosion resistance is created, and is allowed to face the steam turbine rotor blade in the oil not shown.

Si does not damage another member (turbine rotor blade) even if electric discharge is continued for a long time, and therefore the shape may be followed by electric discharge. In the treatment of attaching another material through the conventional welding, thermal spraying, or brazing, heat input is large and the member is deformed. On the other hand, in the method of the electric discharge surface treatment, because the member is hardly deformed, if the electrode is formed in conformity with the shape of the member, it can be repetitively used without change.

Hence, although the conventional method required human skill, in this embodiment, because work is performed by a machine, a stable treatment can be performed without depending on a person.

Through the above method, the surface layer having the high erosion resistance can be automatically formed on the steam turbine rotor blade. However, it may be hard to form an electrode having a large area.

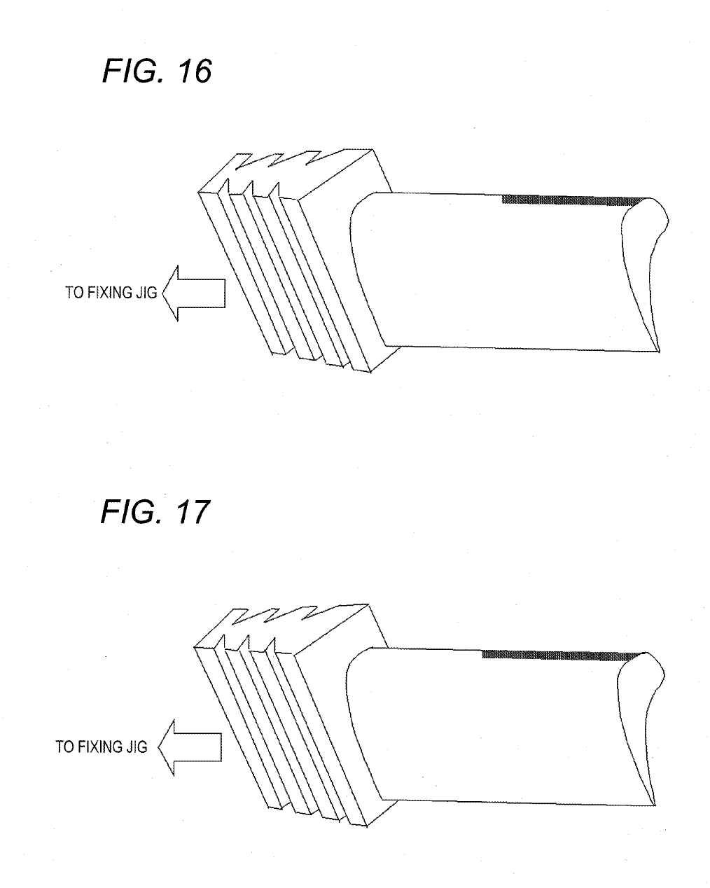

In this case, a thin electrode is produced as illustrated in FIG. 16, and the electrode is scanned according to a treatment progress whereby the entire necessary part can be treated.

Because a front edge of the steam turbine rotor blade is bent, although the electrode shape does not match the shape of the rotor blade cross-section only by scanning with the electrode having the same shape, the thickness of the electrode is thinned to promote the consumption of the electrode, thereby making it easy for the electrode to conform with the shape of the member.

Through the above method, the surface layer having the high erosion resistance can be automatically formed on the steam turbine rotor blade. However, there arises such a problem that it takes long treating time if the treatment area is large. In this case, the electrode is divided into pieces, and electricity is fed to the respective pieces, independently, so that the treating time can be reduced.

A gap between the electrodes is treated while slightly moving the electrodes for a distance larger than the gap, whereby the film can be formed without any gap.

In this embodiment, a case in which the erosion resistant component is applied to the rotor blade of the steam turbine has been described. However, it is needless to say that the same can be applied to other erosion resistant components intended purpose requiring the erosion resistance.

For example, an inner part of a piping which strongly collides with fluid, and a part of a shape where cavitation is liable to occur can be treated in the same manner. Such intended purpose includes a fuel inject component.

### INDUSTRIAL APPLICABILITY

It is useful to apply the surface layer forming method according to the present invention to erosion resistant components.

### REFERENCE SIGN LIST

1, Si electrode; 2, member; 3, machining fluid; 4, DC power supply; 5, switching element; 6, current-limiting resistor; 7, control circuit; 8, electric discharge detector circuit; 11, Si electrode; 12, steam turbine rotor blade; and 13, surface layer including Si

1. A method for forming a surface layer, the method comprising:
arranging a member in a machining fluid; and
forming a surface layer including silicon by spacing an silicon electrode from the member by a predetermined distance, and by supplying silicon component from the silicon electrode to the member side by applying a predetermined voltage between the member and the silicon electrode and generating electric discharge,
wherein a value of an electric discharge detection level, which is for recognizing that the electric discharge is generated when the applied voltage becomes lower than the value, is set to be equal to or larger than a value obtained by adding a voltage depression at the silicon electrode to an arc potential during electric discharge, and
wherein the surface layer including silicon is formed on a surface of the member by repetitively performing, after the voltage is applied, detecting the electric discharge generated between the silicon electrode and the member by detecting a drop of the voltage to be lower than the electric discharge detection level, stopping applying the voltage for a predetermined time after the electric discharge is generated, and applying the voltage again after a predetermined break time.

2. The method for forming a surface layer according to claim 1,
wherein a member having a specific resistance of 0.005 Ωcm or lower is selected as the silicon electrode.

3. The method for forming a surface layer according to claim 1,
wherein the value of the electric discharge detection level obtained by adding the voltage depression at the silicon electrode to the potential of arc during electric discharge is lower than the applied voltage by 10 to 30 V.

4. The method for forming a surface layer according to claim 1,
wherein a current value applied between the silicon electrode and the member when the electric discharge is generated is 4 to 100 μs in pulse width and 1 to 40 A in peak current value, to perform treatment to form the surface layer including silicon on the member surface.

5. A method for forming an erosion resistant component, the method comprising:
spacing an silicon electrode, which is formed in a shape of a portion of the erosion resistant component to be treated, from the portion of the erosion resistant component to be treated, which is arranged in a machining fluid, by a predetermined distance; and
forming a surface layer including silicon on a surface of the erosion resistant component through an electric discharge surface treatment, by repetitively performing, applying a predetermined voltage between the erosion resistant component and the silicon electrode, detecting the electric discharge generated between the silicon electrode and the member by detecting a drop of the voltage to be lower than an electric discharge detection level which is equal to or larger than a value obtained by adding a voltage depression at the silicon electrode to an arc potential while the applied voltage is electrically discharged, continuing the electric discharge for a predetermined time and stopping voltage application for a break time after the continuance of the electric discharge.

6. The method for forming an erosion resistant component according to claim 5,
wherein a member having a specific resistance of 0.005 Ωcm or lower is selected as the silicon electrode.

7. The method for forming an erosion resistant component according to claim 5,
wherein the surface layer including silicon is formed on the surface of the erosion resistant component by conforming a shape of the silicon electrode to the portion of the erosion resistant component to be treated and by performing the electric discharge surface treatment while scanning the silicon electrode.

8. The method for forming an erosion resistant component according to claim 5,
wherein the silicon electrode includes a plurality of electrodes by which the portion of the erosion resistant component to be treated is divided, and
wherein the surface layer including silicon is formed on the surface of the erosion resistant component by applying the voltage to the respective plurality of electrodes, independently and by performing the treatment while slightly moving the silicon electrode.

9. The method of forming an erosion resistant component according to claim 5,
wherein the surface layer which is formed includes a silicon film layer having a thickness of 5 μm or larger and hardness within a range of 600 to 900 HV.

10. A steam turbine blade,
wherein a silicon film layer having a thickness of 5 μm or larger and a hardness within a range of 600 to 900 HV is formed on a front edge of the blade, which is a portion to be treated, through an electric discharge surface treatment.

11. The steam turbine blade according to claim 10,
wherein, in the electric discharge surface treatment, an erosion resistance surface texture including silicon is formed by repetitively generating pulsed electric discharge between the blade and the silicon electrode in a machining fluid.
